(19) United States
(12) Patent Application Publication
(10) Pub. No.: US 2023/0382008 A1
(43) Pub. Date: Nov. 30, 2023

(54) HEMP-BASED BUILDING MATERIAL METHOD

(71) Applicant: Daniel Patterson, N. Palm Beach, FL (US)

(72) Inventor: Daniel Patterson, N. Palm Beach, FL (US)

(21) Appl. No.: 18/187,642

(22) Filed: Mar. 21, 2023

Related U.S. Application Data
(60) Provisional application No. 63/442,050, filed on Jan. 30, 2023.
(60) Provisional application No. 63/346,304, filed on May 26, 2022.

(51) Int. Cl. B27N 3/18; B27N 3/20

(52) U.S. Cl. CPC B27N 3/18; B27N 3/20; E04C 3/36

(57) ABSTRACT

A method of making a structural member from hemp stalks includes feeding a plurality of the hemp stalks into a baler that bundles and aligns the hemp stalks in a common axial direction. A hemp cord is used to bound the hemp stalks into a continuous hemp extrusion, which is then cut into a plurality of hemp logs that are then saturated with an adhesive mixture by an adhesive sprayer that coats each side of the hemp log, or a dip tank. Each hemp log is then introduced into a mold and compressed by 60%-80% to form an interlocking hemp board, a plurality of which are combined to form the structural member after drying by applying the adhesive mixture and then compressing the plurality of interlocking hemp boards in a press until cured. Such a structural member may then be further cut into a finished product, such as two-by-fours.

### CROSS-REFERENCE TO RELATED APPLICATIONS

This application claims the benefit of U.S. Provisional Patent Application 63/346,304, filed on May 26, 2022, and U.S. Provisional Patent Application 63/442,050, filed on Jan. 30, 2023, both incorporated herein by reference.

### STATEMENT REGARDING FEDERALLY SPONSORED RESEARCH AND DEVELOPMENT

Not Applicable.

### FIELD OF THE INVENTION

This invention relates to building materials, and more particularly to a method of making structural building materials with hemp stalks.

### BACKGROUND

Hemp products have grown in popularity due to the strong fibers found in cannabis plants, particularly in their stalks. A variety of products are available that utilize hemp fibrous materials. However, such existing products do not take advantage of additional strength that can be obtained by aligning hemp stalks in a common orientation when manufacturing hemp structural products.

Therefore, there is a need for a method of making structural products from hemp stalks that aligns the hemp stalks in substantially a common direction. Such a needed method would provide for an interlocking hemp board that can be stacked to produce larger structural products when compressed with adhesive. Such larger structural products could then be cut into standard products, such as two-by-fours. The present invention accomplishes these objectives.

### SUMMARY OF THE INVENTION

The present invention is a method of making a structural member from hemp stalks. The hemp stalks are typically produced by a harvester by harvesting cannabis plants and stripping off the leaves and flowers. A plurality of the hemp stalks are fed into a baler that bundles and aligns the hemp stalks in a common axial direction. Preferably a hemp cord is used to bound the hemp stalks into a continuous hemp extrusion. A saw cuts the hemp extrusion into a plurality of hemp logs at predetermined lengths, such as eight feet or twelve feet.

At this point each hemp log is saturated with an adhesive mixture that includes an adhesive and possibly a nano-crystalline cellulose, tannic acid, and/or FeCl3. An adhesive sprayer coats each side of the hemp log and saturates the hemp log between many if not most of the hemp stalks. The hemp log can also be saturated with the adhesive mixture using a dip tank, or the like.

The adhesive-saturated hemp log is then introduced into a mold and compressed with a hydraulic press, or the like, to compress the hemp log by 60%-80% and to conform the hemp log to the shape of the mold, forming an interlocking hemp board. Once cured, such a hemp board is stable if needing to be stored for a period of time.

A plurality of such interlocking hemp boards can be combined to form the structural member, a larger structural material, by applying the adhesive or the adhesive mix to each of the plurality of interlocking hemp boards, and then compressing the plurality of interlocking hemp boards in another press until cured. Such a larger structural material or member may then be further cut into a finished product, such as two-by-fours, or the like.

The present invention is a method of making structural products from hemp stalks that aligns the hemp stalks in substantially a common direction. The present method provides for an interlocking hemp board that can be stacked to produce larger structural products when compressed with adhesive. Such larger structural products can then be cut into standard products, such as two-by-fours. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a diagram of a method of the invention.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

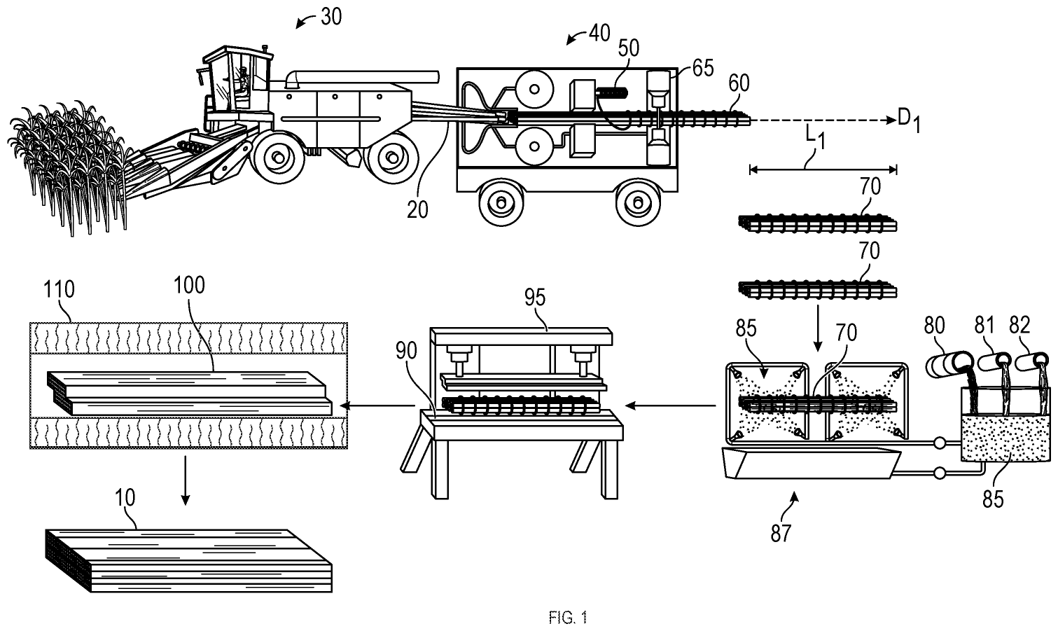

FIG. 1 illustrates a method of making a structural member 10 from hemp stalks 20, preferably from Cannabis sativa L or a similar strain.

The hemp stalks 20 are typically produced by a harvester 30 by harvesting hemp plants and stripping off the leaves and flowers. A plurality of the hemp stalks 20 are fed into a baler 40 that bundles and aligns the hemp stalks 20 in a common axial direction D₁. Preferably a hemp cord 50 is used to bound the hemp stalks 20 into a continuous hemp extrusion 60. A saw 65 cuts the hemp extrusion 60 into a plurality of hemp logs 70 at predetermined lengths L₁, such as eight feet or twelve feet.

At this point each hemp log 70 is saturated with an adhesive mixture 85 that preferably includes an adhesive 80, such as LignoBond 870L adhesive produced by LignoTech Florida, or the like. The adhesive mixture 85 may further include a nano-crystalline cellulose 81 at 5-8%, tannic acid 82 at 5-8%, and/or FeCl3 (not shown) at 5-8%. An adhesive sprayer 87 coats each side of the hemp log 70 and saturates the hemp log 70 between many if not most of the hemp stalks 20.

The adhesive-saturated hemp log 70 is then introduced into a mold 90 and compressed with a hydraulic press 95, or the like, to compress the hemp log 70 by 60-80% and conform to the shape of the mold 90, forming an interlocking hemp board 100. Such a hemp board 100 is stable if needing to be stored for a period of time. Thereafter the hemp boards may be dried at a temperature of 150 degrees for one to three hours in a drying apparatus 110.

A plurality of such interlocking hemp boards 100 can be combined to form the structural member 10 by applying the adhesive 80 or the adhesive mix 85 to each of the plurality of interlocking hemp boards 100, and then compressing the plurality of interlocking hemp boards 100 in another press 95 until cured. Such a structural member 10 may then be further cut into a finished product (not shown), such as two-by-fours, or the like.

While a particular form of the invention has been illustrated and described, it will be apparent that various modifications can be made without departing from the spirit and scope of the invention. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A method of making a structural member from hemp stalks, comprising the steps:
moving the hemp stalks produced by a harvester into a baler;
the baler orienting the hemp stalks in a common axial direction;
binding the hemp stalks together with a hemp cord into a continuous hemp extrusion;
cutting the hemp extrusion into a plurality of hemp logs of a predetermined length; and
compressing the hemp log in a mold to form an interlocking hemp board.

2. The method of claim 1 further including the step:
treating each hemp log with an adhesive.

3. A method of making a structural member from hemp stalks, comprising the steps:
moving the hemp stalks produced by a harvester into a baler;
the baler orienting the hemp stalks in a common axial direction;
binding the hemp stalks together with a hemp cord into a continuous hemp extrusion;
cutting the hemp extrusion into a plurality of hemp logs of a predetermined length;
providing an adhesive mixture comprising and adhesive mixed with nano-crystalline cellulose and tannic acid;
compressing the hemp log in a mold to form an interlocking hemp board;
determining a final structural member to make with a plurality of the interlocking hemp boards;
treating each interlocking hemp board with the adhesive mix;
drying the hemp boards at a temperature of 150 degrees for one to three hours; and
combining the interlocking hemp boards under pressure to form the final structural member.

4. The method of claim 1 3 including the step:
treating each hemp log with an adhesive.
